(19) United States
(12) Patent Application Publication
(10) Pub. No.: US 2010/0254799 A1
(43) Pub. Date: Oct. 7, 2010

(54) WIND ENERGY DEVICE

(76) Inventor: Clynton Caines, Suffolk, VA (US)

Correspondence Address: DUNCAN G. BYERS PC, 142 W. York Street, Suite 910, NORFOLK, VA, 23510, US

(21) Appl. No.: 12/424,092

(22) Filed: Apr. 15, 2009

Related U.S. Application Data
(60) Provisional application No. 61/165,818, filed on Apr. 1, 2009.

(51) Int. Cl. F03D 7/06

(52) U.S. Cl. 415/36; 415/148

(57) ABSTRACT

A shroud for vertical axis wind turbines. The shroud contains vanes that direct airflow to the turbine blades to increase efficiency. The vanes in the shroud further provide a means to close entirely the turbine from adverse weather conditions. The vanes are operated utilizing electrical feedback from the rotational speed of the turbine.

This application claims the benefit of Provisional Application No. 61/165,818, filed Apr. 1, 2009.

### FIELD OF THE INVENTION

The present invention relates to wind turbines used to convert wind energy into mechanical energy, and more particularly relates to vertical axis wind turbines. The present invention provides automated control of the wind volume felt by the working surface of turbine blades, and more particularly increases the range of wind speeds in which a vertical axis wind turbine may operate. The present invention further provides high wind protection for the turbine device, shielding the turbine from high speed damaging winds.

### BACKGROUND

The present invention relates to a combination wind generator and removable shroud design used to convert wind energy into electrical energy. While best suited for use with the Savonius mode, the present invention more specifically relates to a vertical axis wind turbine employing any design of blades, that is encompassed within a removable shroud that rotates about the turbine, is square or round in shape, and is comprised of eight (8) equidistant fins or shutters, in a manner whereby each shutter is capable of pivoting from a single point of affixation from its fully closed position to a position perpendicular to the outer surface of the frame of the shroud, thereby adjusting and redirecting the volume of air flow to the turbine based on the velocity of the wind. The present invention is designed to employ air flow resulting from a full range of wind conditions with the ability to withstand severe weather conditions and avoid damage. In addition, the present invention is capable of being manufactured in various sizes. Overall, the present invention is intended for use as an efficient, cost effective source of electrical energy.

Since ancient times, man has sought to harness the wind as a source of energy. The resulting evolution of devices to capture the energy of the wind has resulted in the development of devices ranging from sails for boats, to windmills used for grinding grain and pumping water, and to modern-day wind turbines used to convert the power of wind into mechanical energy and electrical energy.

Perhaps the most ubiquitous means of capturing wind energy today utilizes a wind turbine. Wind turbines are utilized to convert wind energy into electrical energy. Modern wind turbines utilize two common design groups: the horizontal axis wind turbines (HAWTs) and vertical axis wind turbines (VAWTs). HAWT designs, perhaps the most popular between the two types of turbines, employ blades that rotate perpendicular to the ground. It is this design that is most commonly associated with windmills and, according to one source, at some point after the 12^{th} century, such windmills were being widely used in Holland, England, France, and Germany. Since that time, improvements were made upon the basic windmill designs. Most notably, during the 1390's, the Dutch made significant improvements to the HAWT design by integrating the concept of lift into the design of the windmill blades. Today, according to one source, Denmark obtains nearly 25% of its electricity from the wind, while the U.S. currently obtains less than 1% from the wind.

VAWTs, according to historical accounts, have been utilized beginning as long ago as 500-900 A.D. in Persia. These ancient windmill systems converted wind energy for grinding grain and pumping water. The first use of a large windmill to generate electricity in 1888 is credited to Charles F. Brush. The first electrical output wind machine that employed aerodynamic design features was developed in 1891 by Dane Poul La Cour. With the subsequent emergence of cheaper, larger fossil-fuel steam plants, however, further development of wind energy technology was somewhat stalled until recently, with the prospects of fossil-fuel shortages creating a renewed interest in non-fossil fuel energy sources such as wind.

Thus, with the increasing demand for alternative energy sources, prompted, in part, by eminent fossil-fuel shortages and growing global concerns as to the detrimental impact of the extraction, processing, and consumption of fossil-fuels on the environment, there is re-invigorated interest in further developing efficient means to harness wind energy to create electrical power.

### DESCRIPTION OF PRIOR ART

There are many U.S. patents that relate to wind turbine designs, including those that employ protective shrouds, such as U.S. Pat. No. 372,300; U.S. Pat. No. 537,494; U.S. Pat. No. 1,460,114; U.S. Pat. No. 1,677,745; U.S. Pat. No. 1,812,400; U.S. Pat. No. 1,974,008; U.S. Pat. No. 2,059,356; U.S. Pat. No. 3,942,909; U.S. Pat. No. 4,031,405; U.S. Pat. No. 4,237,384; U.S. Pat. No. 4,350,900; U.S. Pat. No. 4,474,529; U.S. Pat. No. 4,818,181; U.S. Pat. No. 5,332,354; U.S. Pat. No. 5,391,926; U.S. Pat. No. 6,638,005 B2; U.S. Pat. No. 6,740,989; U.S. Pat. No. 6,911,745; and U.S. Pat. No. 7,400,057.

None of the prior art, however, including those noted herein, disclose or suggest the present invention. The prior art is limited by a host of problems that to date have prevented commercial viability. In this regard, U.S. Pat. No. 3,942,909 and U.S. Pat. No. 4,818,181 relate to wind turbines that are designed to pivot to an open position and/or fold in variable wind conditions to protect the structural integrity of the device. Due to the nature of the design, however, these apparatuses decrease the ability to generate power. Prior art such as U.S. Pat. No. 4,474,529 employ various moving parts such as pivoting shields and vanes. However, such designs detract from the devices' overall efficiency.

And, there is a recognized need in the field for designs that incorporate feedback mechanisms that react to changing wind conditions. For example, U.S. Pat. App. No. 2007/0257494 incorporates turbine blades that adjust the angular position of the blades in response to changing wind and speed conditions. However, that design requires complicated mechanical linkages and controls on the blade surfaces themselves. In addition, during extremely high wind conditions, the wind force is still expressed against the surface of the blades. And, finally, that design requires a completely new construction of wind turbine.

In contrast, the present invention is designed such that it may be utilized as a retrofit for an existing VAWT, as the shroud encompassing the present invention may be installed over an existing VAWT. In addition, the present invention provides high wind protection for turbine blades with a separate structure, protecting the VAWT from all force resulting from extreme weather conditions. Finally, the present invention provides a range of wind force control based upon feedback from the turbine, without the need to change the configuration or design of existing blades; the present invention controllably reduces or increases the wind force available to a turbine without any physical changes to the turbine mechanism itself. In a preferred embodiment, the present invention further provides control of the wind force available to a turbine through an electromechanical feedback mechanism

The present invention relates, in particular, to VAWTs. And, more specifically, to an improved means of enhancing and controlling the airflow available to the blades of a vertical wind turbine.

Problems with current inventions include high cost of fabrication, compromised efficiency, high maintenance costs, constant repairs, dangerous designs, and complications due to variable wind velocity and wind direction. These concerns have not been adequately addressed in the prior art. The present invention addresses prominent disadvantages and issues relating to the prior art. One object of the present invention is to provide a wind turbine means that offers low manufacturing costs, high efficiency of power production by way of its ability to increase the volume of air flow to the turbine, low maintenance, accommodation of wind reception from 360 degrees (any direction). While certain features of the invention are known, the present invention offers a novel configuration of old and new elements to achieve a highly efficient, cost effective source of electrical power. Much of the prior art seeks to increase the wind velocity as a means of increasing the efficiency of the turbine system to produce power. The design of the current invention, however, increases the swept area, thereby significantly increasing the efficiency of the turbine and ultimately increasing the power output in a cost efficient manner.

The shroud design is an economic effective and efficient way to regulate incoming wind of a velocity range more broad than that accommodated by the prior art, the regulation of which results in a much higher energy/power output. The present invention provides significant advantages over existing designs in: low maintenance, increased efficiency, low cost to manufacture, flexibility of blade design, and the ability to efficiently protect the turbine from adverse weather.

### SUMMARY OF THE INVENTION

The present invention provides a shroud and feedback mechanism for vertical axis wind turbines. The shroud is positioned around the rotational circumference of the turbine blades. The shroud is constructed with a frame within which moveable vanes are mounted. A mechanical linkage mechanism operates the vanes, causing them to open and close in response to an electrical signal generated by the rotation of the vertical axis of the wind turbine. The vanes direct airflow into the interior space created by the shroud and occupied by the wind turbine blades. An electrical generator mechanically connected to the vertical shaft of the turbine generates a control voltage; because the voltage generated increases and decreases with increases and decreases in rotational velocity of the turbine, the electrical generator produces a feedback signal that is utilized to control the volume of air redirected by the vanes. As external wind speed decreases and the rotation of the turbine blades slows as a result, the control voltage decreases, causing the mechanical linkage controlling the vanes to actuate and open the vanes. As external wind speed increases and the rotation of the turbine blades speeds up as a result, the control voltage increases, causing the mechanical linkage controlling the vanes to actuate and close the vanes. The number of vanes may be varied, but experimental results have shown the optimal number of vanes to be eight. Further, as opposed to the fixed vane design such as that shown in U.S. Pat. No. 5,391,926 to Staley, et al., because the vanes in the present invention are moved in relation to the wind speed, the invention will rarely, except in the highest wind speed conditions when the shroud is completely closed to external air in order to protect the turbine, feel wind forces arrayed perpendicular to the surface of the vanes. The present design, therefore, reduces the force imparted on the stationary structure of the shroud.

Vertical axis windmills are generally designed such that the turbine blades expose a concave surface to incoming wind, causing resistance by “capturing” the force of the wind and thereby causing the blades to be pushed in front of, and in the direction of, the incoming wind. In order to reduce the resistance of a blade that is rotating into position to receive the force of the incoming wind, most modern vertical axis windmills incorporate some means to reduce the wind force acting against the direction of rotation. This is generally accomplished by designing the blades such that the reverse side (i.e., the non-working surface) of each blade has a convex non-working surface in order to redirect airflow away from the blade, thereby reducing the force imparted on the windmill against the direction of rotation.

The present invention, however, negates the problem of that negative force against the non-working surface by directing the wind force only to the working surface of the windmill blades. The vanes are oriented such that incoming wind flow is directed to one side of the shroud, that side being the portion of the shroud where, relative to the direction of the wind, the effective sides of the windmill blades rotate into the wind with the working surface exposed to the force of the wind. Not only does this reduce in part or in whole the force against the direction of rotation of the windmill, but the invention also redirects the force that would otherwise have pushed against the rotation into the working faces of the windmill blades. In this manner, generally, the present invention allows for a vertical axis wind turbine to operate effectively at lower wind velocities than those without the shroud described herein, and to safely operate at higher wind velocities that are beyond the safe operational range of a wind turbine. The invention disclosed herein further allows for the wind turbine to be isolated completely from high wind conditions as needed.

The present invention further allows for automated control of the rotation of the vanes about their individual axes of movement, with the vanes being moveable from a fully closed position to a maximum open position. The maximum open position varies according to the specific design and geometry of both the windmill and the shroud. Regardless of the design and geometry particulars, however, the vanes of the shroud preferentially will not open in such a manner as to allow a wind force to be imparted against the non-working surfaces of the windmill blades. The individual vanes are mechanically linked to a common mechanism that opens and closes the vanes in unison. That mechanism, in turn, is controlled by the electrical signal generated by the electrical generator described above.

Yet a further advantage of the present invention is that it provides a device that may readily be adapted for and added to any existing vertical axis wind turbine.

The present invention, in its various embodiments, provides a significant improvement over existing means to control the wind flow to wind energy devices. And, although the invention as described herein relates to wind turbines for the generation of electrical power, the advantages provided by this invention apply regardless of the end recipient of the power or motive force generated by a vertical wind turbine that utilizes the present invention. It will be further understood that, although the present invention is described herein as controlling the flow of air to a turbine, the invention may as well be utilized with other fluids and/or gases, e.g., water.

It is therefore an object of the present invention to provide a design for a shroud to control the air flow directed to the working surfaces of the blades of a vertical axis wind turbine.

It is a further object of the present invention to provide a design for a shroud to increase the volume of wind available to drive a windmill.

It is a further object of the present invention to provide a design for a shroud to redirect air flow away from the non-working surfaces of the turbine blades of a vertical axis wind turbine.

It is yet a further object of the present invention to provide a shroud for controlling air flow to a vertical axis wind turbine,

### DESCRIPTION OF THE DRAWINGS

FIG. 1 is a top view of the present invention with the vanes open to the outside air.

FIG. 2 is a top view of the present invention showing the vanes closed to the outside air.

FIG. 3 shows air flow into the present invention.

FIG. 4 is another embodiment of the present invention.

### DESCRIPTION OF THE PREFERRED EMBODIMENTS

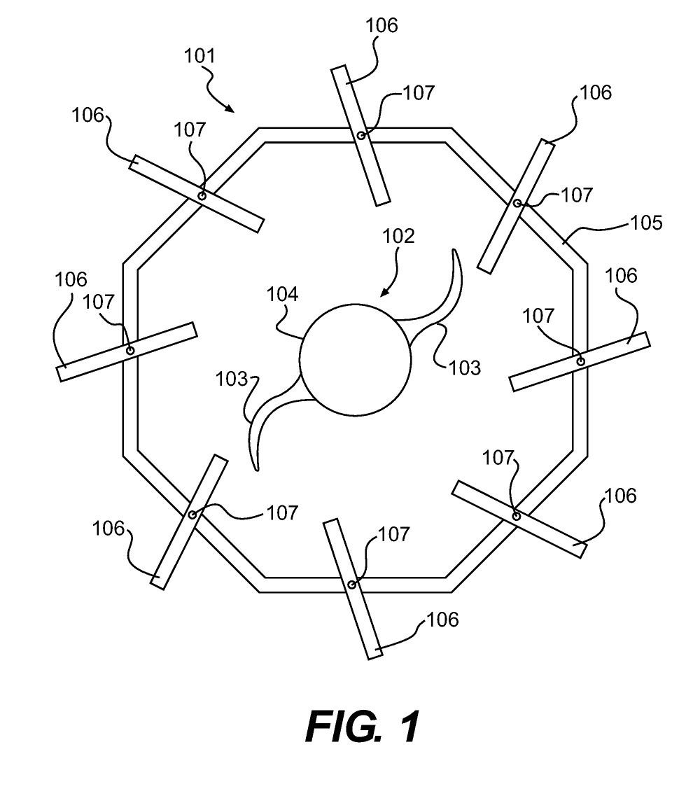

Referring to FIG. 1, the present invention comprises a housing 101 positioned around a central vertical windmill 102. Standard modern vertical windmill designs are configured to capture wind energy with blades 103, that wind energy being converted to rotational energy imparted on a vertical shaft 104. The housing 101 consists of a frame 105 in which are situated a plurality of vanes 106. Although any number of vanes 106 may be utilized, experimental use has shown that an optimal number of vanes 106 is eight, with the housing 101 being generally octagonal. It will be understood by those skilled in the art that, although the embodiment shown herein comprises a generally octagonal shape, other shapes may be used without deviating from the spirit and scope of the present invention. Although other housing 101 shapes may be used, it is preferred that the numbers of sides of the housing 101 correspond to the number of vanes 106. In this manner, the amount of material necessary to construct the present invention is reduced, thus reducing the cost as well as the wind profile of the housing 101.

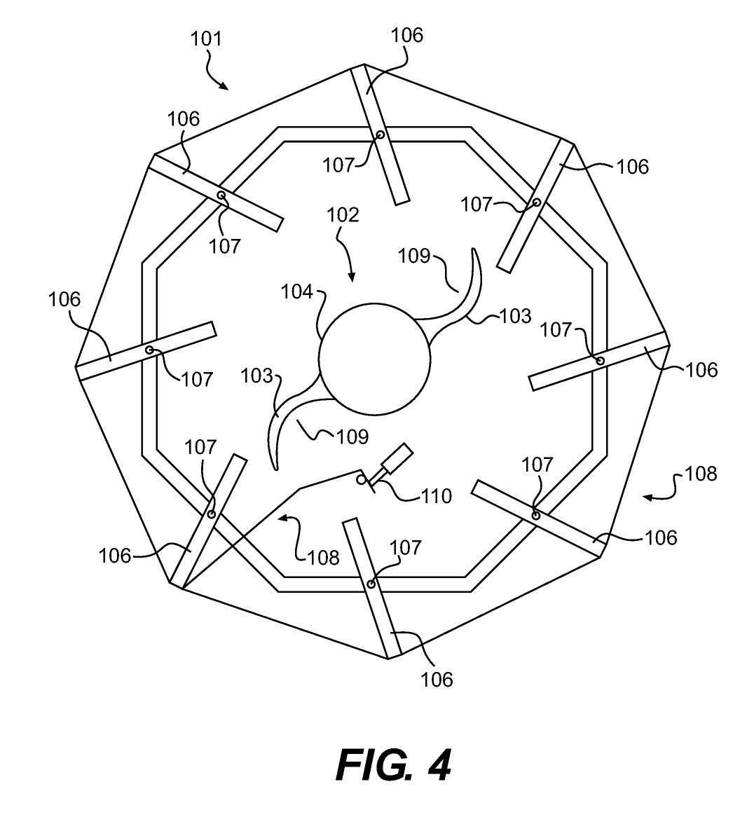

The plurality of vanes 106 are pivotally mounted to the housing 101. Although the pivot points 107 may be located at any point along the axis of the vanes 106, the pivot points 107 are preferentially located at the midpoint of the vanes 106. Referring now to FIG. 4, the invention further comprises means for moving the vanes 106 about the pivot points 107, the means comprising mechanical linkages 108.

Although the mechanical linkages 108 may be operated by numerous means, in a preferred embodiment the linkage is operated utilizing an electromechanical impetus. An electric generator (not shown) is mechanically attached to or associated with the vertical shaft 104 by commonly utilized means, such as a wheel or gear. A means for attaching and/or connecting to an electric generator to generate parasitic power is well known in the art. The electric generator creates an increase or decrease in voltage in response to increases or decreases in rotational velocity of the vertical shaft 104. In this manner, the present invention may have pre-set operating limits so that the effective wind velocity seen by the working surfaces 109 of the blades 103 is maintained within a range that provides the maximum possible force to the blades 103 without exceeding operating parameters of the vertical axis wind turbine. In particular, as the wind speed increases and the rotational velocity of the vertical axis 104 increases, the electric generator increases the output voltage, causing an electric drive or servo 110 to activate in such a manner as to move the mechanical linkages 108 to decrease the openings into the shroud by closing the vanes 106. As the wind speed decreases and the rotational velocity of the vertical axis 104 decreases, the electric generator decreases the output voltage, causing an electric drive or servo 110 to activate in such a manner as to move the mechanical linkages 108 to increase the openings into the shroud by closing the vanes 106. It will be understood by those skilled in the art that the voltage range corresponding to the wind speed range will vary depending upon the application, design, desired operating parameters, and operating limits of a particular vertical axis wind turbine.

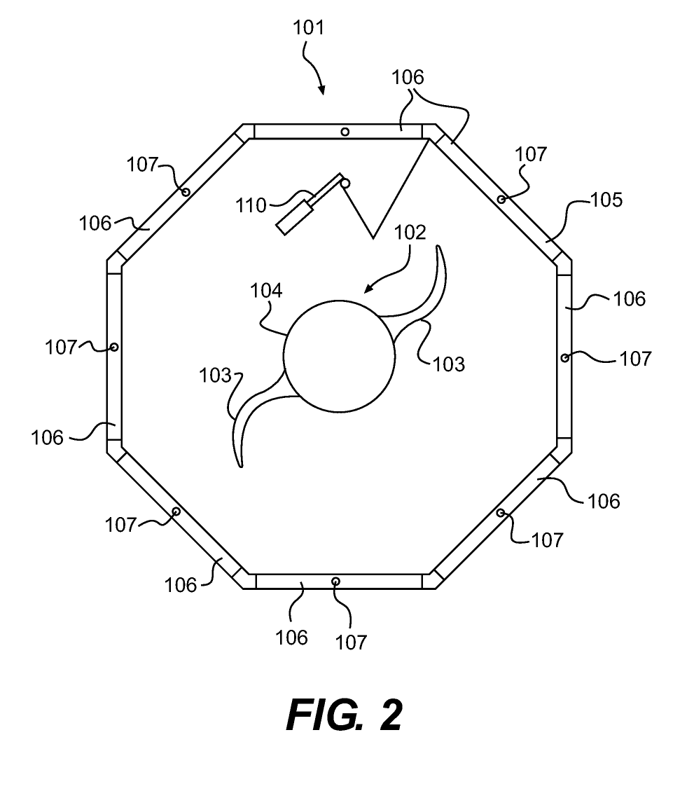

It will further be understood by those skilled in the art that the plurality of vanes 106 may be varied without deviating from the spirit and the scope of the present invention. The preferred embodiment, however, comprises eight (8) vanes 106, as shown in FIGS. 1-4. In that particular configuration, the greatest wind controlling advantage is obtained as described above, while comprising a small circumference in relation to the blades 103, thereby reducing both manufacturing costs, by constructing the present invention with as few materials as possible, while most importantly reducing to a minimum the dead air space within the housing and simultaneously eliminating any unwanted back force on the non-working side of the blades 103.

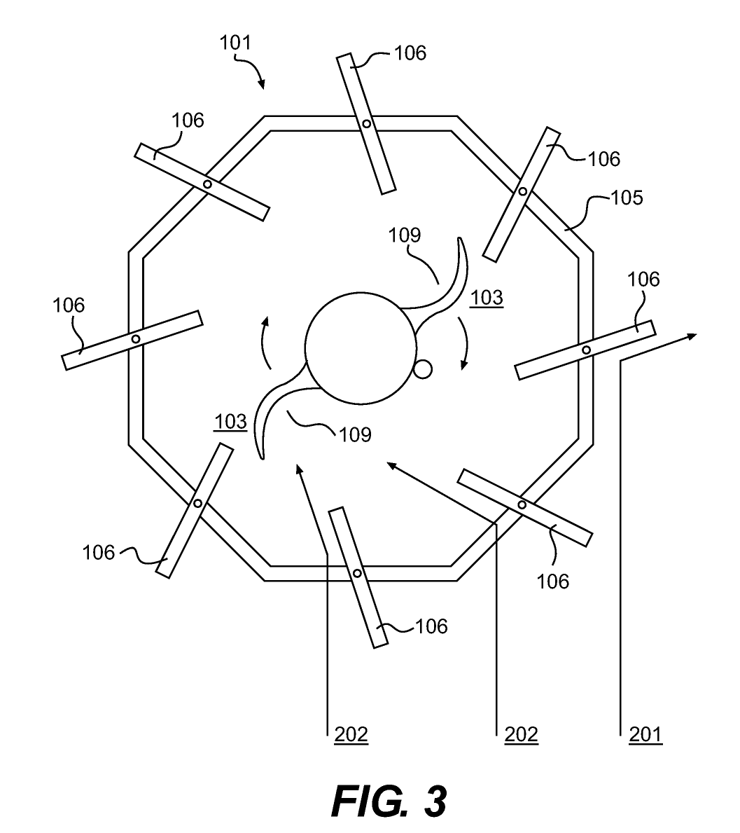

Referring now to FIG. 3, an embodiment of the present invention is shown with representative airflow into the housing 101 and redirected by the vanes 106. As shown, the airflow 201 is directed by the vanes 106 to the working surface 109 of the turbine blades 103. That portion of the wind 202 that would, without the invention herein, impact the non-working surface of the blades 103 and cause force to be imparted against the desired direction of rotation.

It will be understood that the blades may be of any design, the embodiment described herein is the most advantageous.

It will further be understood that the shroud may be open or closed at the top and/or bottom, or some variant thereof depending upon the application. Generally, the device as preferred has less material and an open top, which does not impact performance.

The invention has been described in detail with particular reference to the preferred embodiment thereof, but it is understood that modifications and variations of the invention can be made without deviating from the spirit and scope of the invention.

What is claimed is:

1. A wind turbine housing, the housing comprising:
A housing structure;
A plurality of vanes arranged circumferentially about the frame of said housing;
The vanes hingedly connected to the housing;
Mechanical means for moving the said vanes relative to the said housing;

2. The wind turbine housing of claim 1, wherein said wind housing is generally cylindrical.

3. The wind turbine housing of claim 1, wherein the said housing structure comprises an open frame.

4. The wind turbine housing of claim 1, wherein the shape of said wind housing is determined by the number of the plurality of vanes.

5. The wind turbine housing of claim 1, wherein the number of said plurality of vanes is greater than 3.

6. The wind turbine housing of claim 1, wherein said wind housing is positioned around the rotational circumference of the turbine blades.

7. The wind turbine housing of claim 1, wherein the said mechanical means for moving the said vanes relative to the said housing comprises mechanically hinged linkages, those linkages pivotally connected to the said vanes and to one another, the linkages further mechanically connected to electric motor means for moving said mechanical linkages and thereby rotating said vanes open and closed in relation to the housing.

8. The wind turbine housing of claim 7, wherein said mechanically hinged linkages are pivotally connected to the said vanes at a point distal to the hinge portions of the said vanes.

9. The wind turbine housing of claim 1, further comprising a sensor means for determining the rotational speed of a vertical wind turbine.

10. The wind turbine housing of claim 9, wherein said sensor means produces an electrical voltage that increases and decreases relative to the rotational speed of a vertical wind turbine.

11. The wind turbine housing of claim 10, wherein said electrical voltage produced by said sensor means is electrically transmitted to a means for moving said mechanical linkages.

12. The wind turbine housing of claim 11, wherein said means for moving said mechanical linkages comprises an electronic control means and an electrical drive unit, said electronic control means being electrically connected to said electrical drive unit, and said electrical drive unit being mechanically linked to said mechanical linkages.

13. The wind turbine housing of claim 12, wherein said electrical drive unit is operated in response to the electronic control means, the electronic control means receiving the electrical voltage produced by said sensor means and thence providing electrical power to the electrical drive unit to move said mechanical linkages in response to changes in the rotational speed of a wind turbine.

14. The wind turbine housing of claim 12 wherein said electrical drive unit is a servo.

15. The wind turbine housing of claim 12 wherein said electrical control means operates the said electrical drive unit in accordance with a preset range of electrical voltage produced by said sensor means.

16. The wind turbine housing of claim 12 wherein said mechanical linkages operate the said vanes in relation to the housing from a full open position to a full closed position.

17. A wind turbine housing of claim 15 and a pre-set range of voltages causes the position of the vanes to change in accordance with pre-set values.

18. The wind turbine housing of claim 16, wherein said vanes are fully closed when the rotational speed of the wind turbine exceeds preset parameters.
